(19) United States
(12) Patent Application Publication
(10) Pub. No.: US 2006/0124393 A1
(43) Pub. Date: Jun. 15, 2006

(54) Ladder support apparatus

(76) Inventor: Graham Robinson, Staffordshire (GB)

Correspondence Address: BARLOW, JOSEPHS & HOLMES, LTD., 101 DYER STREET, 5TH FLOOR, PROVIDENCE, RI, 02903, US

(21) Appl. No.: 10/535,749

(22) PCT Filed: Nov. 18, 2003
(86) PCT No.: PCT/GB03/05008

§ 371 Date: Jan. 23, 2006

(30) Foreign Application Priority Data
Nov. 22, 2002 (GB) 0227251.6

(51) Int. Cl. E06C 7/42

(52) U.S. Cl. 182/107

(57) ABSTRACT

A ladder support apparatus includes a base member with a ground engaging part on the underside thereof with a plurality of spikes engageable with the ground. A ladder engaging part is provided with a top side of the base member and includes a plurality of upstanding spike engageable with the feet of a ladder to prevent slipping thereof.

This invention concerns ladder support apparatus, and particularly but not exclusively apparatus for preventing ladders slipping on the ground in use.

Ladders are used in a wide range of situations. Problems can be encountered with the feet of ladders slipping on the ground, and especially where the ground is quite slippery. This can cause the ladder to fall with potentially serious consequences for anybody on the ladder. Also, with soft ground a ladder can often penetrate into the ground a significant distance, which may damage for instance a lawn. Also, if only one leg of the ladder penetrates the ground to a significant degree, this could cause the ladder to fall over.

According to the present invention there is provided ladder support apparatus, the apparatus comprising a base member, a ground engaging part provided on the underside of the base member which part includes at least twenty ground engaging upstanding projections, and a ladder engaging part provided on the top side of the base member, the ladder engaging part, being engageable with the feet of a ladder so as to substantially prevent slippage thereof.

The ladder engaging part preferably includes at least twenty upstanding projections which are engageable with the feet of the ladder. The upstanding projections are preferably pointed. The upstanding projections may be provided by a pressed plate, which plate may be made of steel and may be galvanised.

The ground engaging part and/or ladder engaging part may comprise a section of pressed galvanised steel plate.

An abutment member against which the feet of a ladder can abut, may be provided on the top side of the base member. The abutment member may be upstanding from the base member, and may have a generally shallow U-shape in plan view.

The apparatus may include a handle, which handle may be in the form of an opening in the base member.

The ground engaging part preferably has greater than one hundred projections, desirably greater than five hundred projections, and more desirably greater than a thousand projections.

The base member is preferably flexible so as to adopt at least partially to the profile of underlying uneven ground. The base member may be made of plastics material and may be made of polypropylene.

An embodiment of the present invention will now be described by way of example only and with reference to the accompanying drawings, in which:—

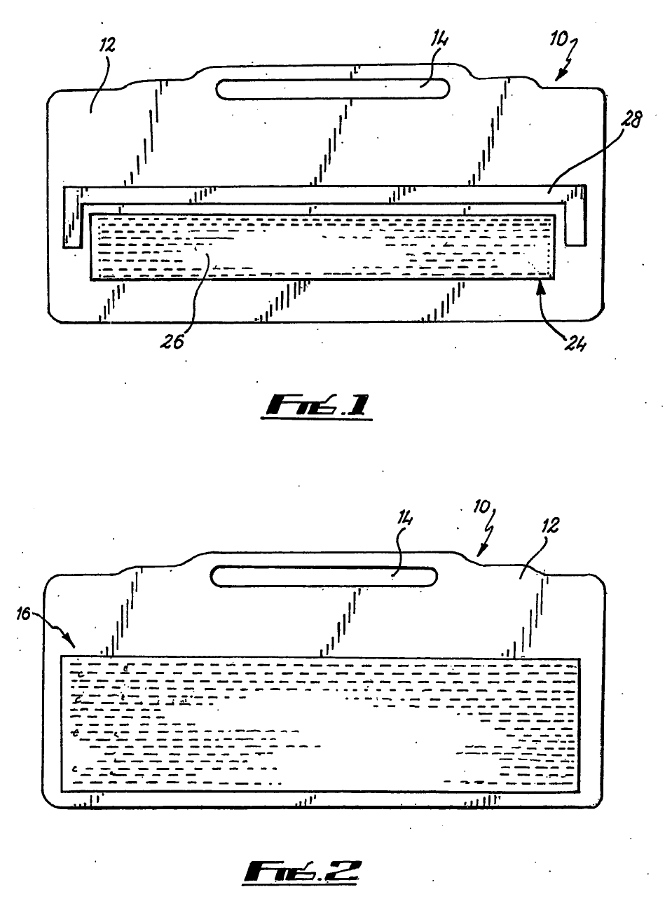

FIG. 1 is a diagrammatic plan view of ladder support apparatus according to the invention;

FIG. 2 is a view from below of the apparatus of FIG. 1;

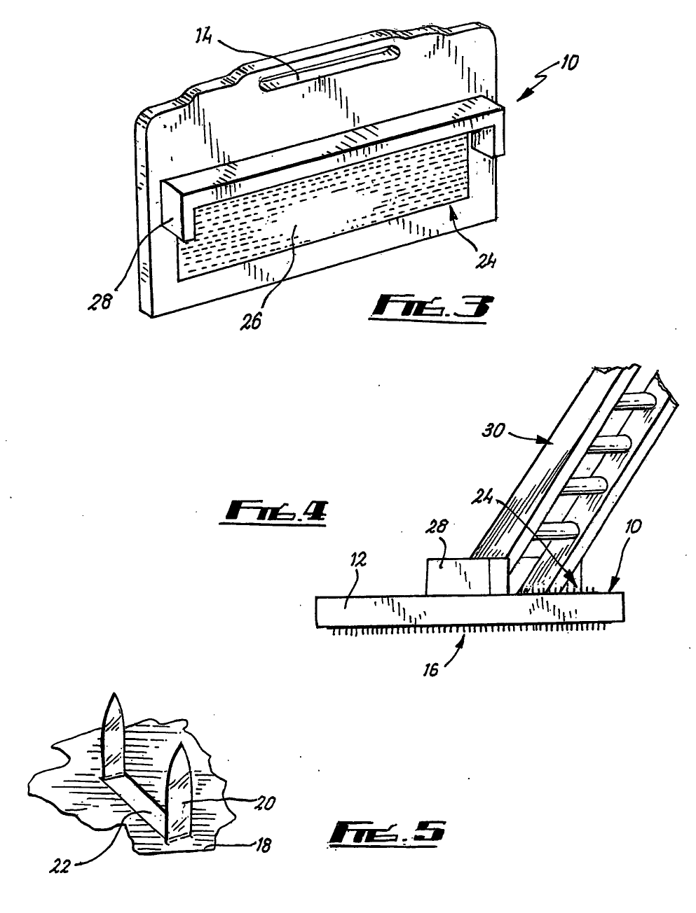

FIG. 3 is a diagrammatic front perspective view of the apparatus of FIG. 1;

FIG. 4 is a diagrammatic perspective side view of the apparatus of FIG. 1 in use; and

FIG. 5 is a diagrammatic perspective view of a detail of the apparatus of FIG. 1.

The drawings show a ladder support apparatus 10. The apparatus 10 comprises a base member 12 made from a sheet of polypropylene. The base member 12 is mainly rectangular but has an extension of one of the longer sides which includes an elongate opening therethrough to provide a handle 14.

A ground engaging part 16 is provided on the underside of the base member 12. The part 16 covers the majority of the underside of the member 12 and comprises a pressed galvanised steel plate 18 which provides a plurality of upstanding spikes 20 formed by pressing holes 22 in the plate and then sharpening the two projections produced by forming the hole. The plate 18 has approximately 1800 spikes. A more detailed view of the spikes 20 is shown in FIG. 5. The plate 18 can be mounted on the base member 12 by any suitable means such as screws, rivets, bolts or adhesive.

A ladder engaging part 24 is provided on the top side of the base member 12. The part comprises a further pressed galvanised steel plate 26 which is similar to the plate 18 but smaller. The plate 26 has approximately 900 spikes.

A ladder abutment member 28 is provided against which the feet of a ladder can abut and to provide for correct positioning of the ladder feet. The member 28 is in the form of an upstanding wall, and has in plan view a shallow U-shape with its base running along one side of the plate 26 and the side limbs extending part way adjacent the ends of the plate 26.

In use the apparatus 10 can be located where it is required to place the feet of a ladder. The ground engaging part 16 provides for a grip on a wide range of surfaces such as tarmac, grass, carpets and even frozen surfaces. The feet of a ladder 30 are placed on the ladder engaging part 24 towards or abutting against the abutment member 28. The ladder engagement part provides a good grip on the bottom of a ladder 30. This arrangement is shown in FIG. 4. The ladder 30 can now be used knowing that the feet of the ladder 30 are securely mounted on the ground, and particularly by the high friction produced by the ground engaging part 16 and the ladder engaging part 24. The polypropylene base member 12 allows a certain amount of flex, and therefore at least partially adopts to any underlying uneven ground. The handle 14 allows the apparatus 10 to readily be carried to wherever required, or to be hung on a wall elsewhere.

There is thus described a ladder support apparatus which provides for greatly enhanced grip on the ground and also the feet of a ladder, but which is yet simple to use and inexpensive to manufacture.

Various modifications may be made without departing from the scope of the invention. For instance the ground engaging part and/or ladder engaging part may take a different form and may have a differing number of projections. Different materials could be used in the construction of the various components of the apparatus 10.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-7. (canceled)

8. Ladder support apparatus comprising:
a base member;
a ground engaging part provided on the underside of the base member, said ground engaging part including at least twenty ground engaging upstanding projections;
a ladder engaging part provided on the top side of the base member, said ladder engaging part being engageable with the feet of a ladder so as to substantially prevent slippage thereof.

9. The apparatus according to claim 8 wherein said ladder engaging part includes at least twenty upstanding projections which are engageable with the feet of the ladder.

10. The apparatus according to claim 9 wherein the upstanding projections are pointed.

11. The apparatus according to claim 9 wherein the upstanding projections are provided by a galvanized steel plate.

12. The apparatus according to claim 10 wherein the upstanding projections are provided by a galvanized steel plate.

13. The apparatus according to claim 8 wherein the ground engaging part comprises a galvanized steel plate.

14. The apparatus according to claim 9 wherein the ground engaging part comprises a galvanized steel plate.

15. The apparatus according to claim 8 wherein an abutment member is provided on the top side of the base member, and the feet of the ladder abut against the abutment during use thereof.

16. The apparatus of claim 15 wherein the abutment member is upstanding from the base member.

17. The apparatus according to claim 9 wherein an abutment member is provided on the top side of the base member, and the feet of the ladder abut against the abutment during use thereof.

18. The apparatus of claim 17 wherein the abutment member is upstanding from the base member.

19. The apparatus according to claim 10 wherein an abutment member is provided on the top side of the base member, and the feet of the ladder abut against the abutment during use thereof.

20. The apparatus of claim 19 wherein the abutment member is upstanding from the base member.

21. The apparatus of claim 19 wherein the abutment member has a generally shallow U-shape in plan view.

22. The apparatus of claim 20 wherein the abutment member has a generally shallow U-shape in plan view.

23. The apparatus of claim 8 further comprising a handle.

24. The apparatus of claim 23 wherein the handle is in the form of an opening in the base member.

25. The apparatus of claim 8 wherein said ground engaging part has greater than one hundred projections.

26. The apparatus of claim 25 wherein said ground engaging part has greater than five hundred projections.

27. The apparatus of claim 26 wherein said ground engaging part has greater than one thousand projections.

28. The apparatus of claim 8 wherein the base member is flexible so as to adapt, at least partially, to the profile of underlying uneven ground.

29. The apparatus of claim 28 wherein said base member is made of plastic material.

30. The apparatus of claim 29 wherein said base member is made of polypropylene.
